(19) United States
(12) Patent Application Publication
(10) Pub. No.: US 2022/0290330 A1
(43) Pub. Date: Sep. 15, 2022

(54) ANTIMICROBIAL ADDITIVE IN WOVEN POLYPROPYLENE FABRICS

(71) Applicant: LUMITE, INC., Alto, GA (US)

(72) Inventors: Ron ROOKS, Suwanee, GA (US); R. Alan SUTTON, Gainesville, GA (US)

(73) Assignee: LUMITE, INC., Alto, GA (US)

(21) Appl. No.: 17/692,260

(22) Filed: Mar. 11, 2022

Related U.S. Application Data
(60) Provisional application No. 63/160,211, filed on Mar. 12, 2021.

(51) Int. Cl. D01F 1/10; D03D 15/283; D03D 15/50; D01D 5/08; B01D 39/08; B01D 39/20; A63B 5/11

(52) U.S. Cl. CPC D01F 1/103; D03D 15/283; D03D 15/50; D01D 5/08; B01D 39/083; B01D 39/2068; A63B 5/11; D10B 2507/00; D10B 2505/04; B01D 2239/0442; B01D 2239/0613

(57) ABSTRACT

Woven polymeric fabrics or materials with antimicrobial additives suitable for example for use in connection with diatomaceous earth pool filters, monofilament pool cartridge filters, and trampoline mats are disclosed. Examples of the woven polymeric fabric of the present invention includes a composition having a polymer and at least one antimicrobial additive. Methods of composing and weaving antimicrobial polymeric materials are also disclosed.

### CROSS-REFERENCE TO RELATED APPLICATIONS

This application claims the benefit of U.S. Provisional Patent Application Ser. No. 63/160,211 filed Mar. 12, 2021, the entirety of which is hereby incorporated herein by reference for all purposes.

### TECHNICAL FIELD

The present invention relates generally to the field of woven polypropylene fabrics, and more particularly to woven polypropylene fabrics with antiviral, antifungal, antibacterial, and/or antimicrobial additives.

### BACKGROUND

There are many microorganisms, including bacteria, viruses, and fungi, that are harmful to individuals. Unfortunately, these microorganisms can grow on surfaces or in mediums and pose serious health hazards if not properly treated. For example, swimming pools particularly utilize filtration systems to filter out harmful microorganisms from the pool water. Two of the most common types of pool water filters used in residential swimming pools are diatomaceous earth filters and monofilament cartridge filters. Both filters utilize some form of filter fabric though which water is pumped or passed. As the pool water is passed through the pool filters, typical filter fabrics filter out unwanted debris or residue too large to pass therethrough. However, microorganisms can collect and grow on the filter fabric itself and, if left untreated, can lead to further growth and spread of the harmful virus, bacteria, and/or fungi. Therefore, inhibiting the growth of microorganisms can be especially critical in certain applications where people may become exposed to those harmful microorganisms.

Topical application of antimicrobials to combat growth of harmful microorganisms is known. However, topical application is not effective and is not long-lasting on some polymeric materials, such as for example polymeric fabrics used in pool filters and trampoline mats, because polymeric materials do not readily absorb topical additives. As a result, topical applications of antimicrobial additives on woven polymeric fabrics tend to wear off quickly and do not remain on the fabric surface for an extended period of time. Accordingly, it can be seen that needs exist for improved woven polymeric fabrics with enhanced antimicrobial, antibacterial, antiviral, and/or antifungal properties, and methods of manufacturing thereof. It is to the provision of a woven polymeric fabric with antimicrobial, antibacterial, antiviral, and/or antifungal properties meeting these and other needs that the present invention is primarily directed.

### SUMMARY

In example embodiments, the present invention provides a woven polymeric fabric or material with antimicrobial additives suitable for example for use in connection with diatomaceous earth pool filters, monofilament pool cartridge filters, and trampoline mats. In example forms, the woven polymeric fabric of the present invention includes a composition comprising a polymer and at least one antimicrobial additive.

In one aspect, the present invention relates to a composition for a polymer yarn comprising at least one polymer and at least one antimicrobial additive. In various example forms, the antimicrobial additive may be antibacterial, antifungal, and/or antiviral.

In another aspect, the invention relates to a polymer yarn. The polymer yarn includes a composition made of at least a polymer and at least an antimicrobial additive. In example forms, the polymer yarn is a monofilament yarn including between about 78% and about 98% of virgin polypropylene and between about 5.25% and about 6% of carbon black additive. In other example forms, the polymer yarn is a fibrillated tape yarn including between about 95% and about 98% of virgin polypropylene and between about 2% and 5% of low density polyethylene or linear low-density polyethylene.

In still another aspect, the invention relates to a woven polymeric fabric including a plurality of polymer yarns. The polymer yarns are made from a composition including at least one polymer and at least one antimicrobial additive. In example forms, the polymeric fabric is configured for use in connection with diatomaceous earth pool filters or monofilament cartridge pool filters. In other example forms, the polymeric fabric is configured for use in connection with trampoline mats.

In yet another aspect, the invention relates to a method of weaving an antimicrobial polymeric material or fabric. The method includes combining a polymer resin with at least one antimicrobial additive and loading the combination into an extruder. The polymer resin and antimicrobial additive are then exposed to heat and pressure in the extruder wherein the polymer resin and antimicrobial additive are melted and blended together into a molten resin mixture. The resin mixture is then passed through a die to form extruded yarns. The extruded yarns are quenched and solidified in water before the solidified, extruded yarns are passed through an orientation or drawing process forming drawn yarns. The drawn yarns are beamed into a warp and placed on a loom. The antimicrobial polymeric material is then weaved together by introducing cross direction yarns to the drawn yarns of the warp. In some example forms, the molten resin mixture may be extruded through a monofilament die or a coat hanger die. In other example forms, the extruded yarns may be passed through the drawing process more than once. In still other example forms, the method further includes a finishing process, such as for example heating setting, calendaring, and/or slitting.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a process flow diagram of a method of manufacturing a woven polymeric fabric with antimicrobial additives according to an example embodiment of the invention.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The present invention relates to a woven polymeric fabric. The woven polymeric fabric generally comprises a plurality of polymer yarns having antimicrobial properties. In example embodiments, the woven polymeric fabric is typically utilized to make filter fabrics or materials for pool water filters, such as for example diatomaceous earth (DE) grid filters and monofilament pool cartridge filters commonly used to cleanse and/or filter water in residential swimming pools. Typical pool water filters utilize filter fabric to catch and filter out debris or refuse from water passing therethrough. Some water filters, such as DE grid filters, incorporate additional substances like diatomaceous earth powder to further improve the filtration process. However, microorganism, such as viruses, fungi, and/or bacteria, may still collect and grow on and/or around the filter fabric itself whereupon the microorganisms can grow to unsafe conditions and spread therefrom if left untreated. According to example embodiments of the present invention, antimicrobial additives are blended into polymer yarns used to produce the woven polymeric fabric to help prevent microorganisms from growing on the fabric and also help remove those harmful microorganisms from the pool water as it passes through the filter fabric.

In another example embodiment, the woven polymeric fabric of the present invention is utilized as mats for trampolines. The inclusion of the antimicrobial additives in the woven polymer fabric helps inhibit growth of bacteria, viruses, and fungi which may pose health risks if transferred to persons using the trampoline. Additionally, the antimicrobial additives help keep the trampoline mat fabric free from algae, mold, and mildew growth which reduces the overall efforts to properly maintain and keep clean the trampolines.

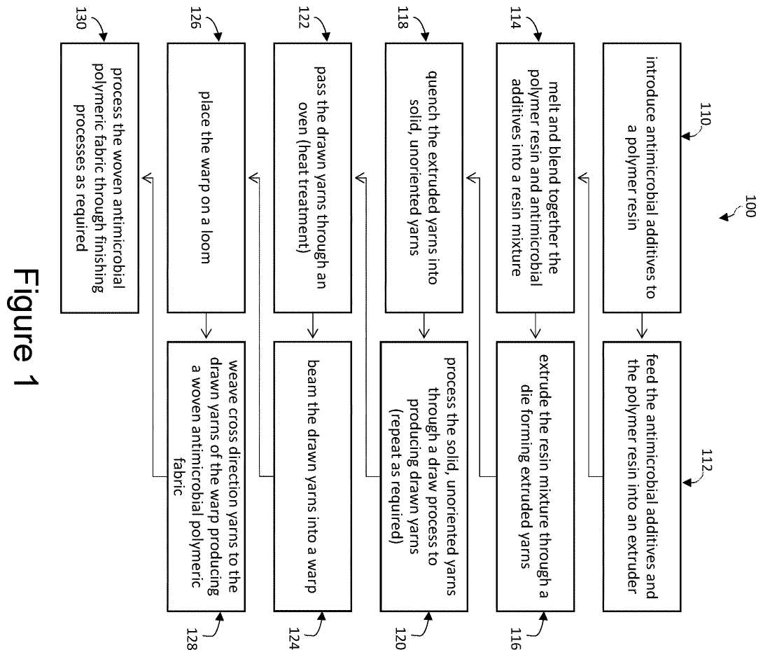

FIG. 1 shows a process or method of manufacturing the woven polymeric fabric according to an example embodiment of the present invention. The process generally includes extruding yarns with antimicrobial additives blended therein, drawing out and heat treating the extruded yarns, beaming the extruded yarns into a warp, weaving a polymeric fabric using the warp, and processing the polymeric fabric through finishing processes as needed. The resulting woven polymeric fabric comprises polymer yarns with antimicrobial additives blended or embedded therein. Therefore, the woven polymeric fabric of the present invention features antimicrobial properties without the need of applying topical antimicrobials which are typically ineffective and not long-lasting when used on certain polymeric materials that do not readily absorb topical additives. As a result, topical applications of antimicrobial additives on such woven polymeric fabrics tend to wear off quickly and do not remain on the fabric surface for an extended period of time. The woven polymeric fabric of the present invention will leech out or disperse antimicrobial additives slowly over time providing longer antimicrobial protection.

As shown in FIG. 1, the method 100 includes at 110 introducing antimicrobial additives to a polymer resin. In example embodiments, the polymer resin is virgin polypropylene resin. The antimicrobial additives can be antiviral, antibacterial, and/or antifungal. Additional additives may be added during this step, including UV additives and processing aids. According to example embodiments, example polypropylene resins can include PPF 600 2085, PP10 525F RPL10, PPF 600 4585, PP20 595 7871, PP20 600 6878, or for example other resins as desired. According to example embodiments, antimicrobial additives can include TOSAF B11798PP EU, TOSAF B18726HP, or for example other antimicrobial additives as desired. According to some example embodiments, the antimicrobial additive is zinc-based or at least some percentage of the additive comprises zinc. According to one example embodiment, the antimicrobial additive comprises zinc oxide. According to another example embodiment, the antimicrobial additive comprises silver sulfate. And according to yet another example embodiment, the antimicrobial additive comprises a combination of zinc or zinc oxide and silver sulfate.

At 112 and 114, the antimicrobial additives and polymer resin are fed into an extruder wherein the antimicrobial additives and polymer resin are exposed to heat and/or pressure which melts and blends the resin with the additives into a molten mixture. In other example embodiments, the polymer resin and additives may be melted and blended elsewhere before being introduced into the extruder. At 116, the molten mixture is passed through an extrusion die to form an extruded, unoriented yarn. According to example embodiments, a monofilament die is used to produce 525F, 565 and 595 denier monofilament yarns and a coat hanger die is used to produce 600 denier fibrillated tape yarns. At 118, the extruded, unoriented yarn from 116 is quenched or turned back to solid in water, or other suitable mediums.

At 120, the quenched, unoriented yarn is passed through an orientation or draw process where the yarn is stretched to affect the strength, elasticity, and dyeability of the yarn as required in the end use of the woven polymer fabric. In example embodiments, the unoriented yarn is stretched to enhance its strength and reduce its elasticity. The unoriented yarn may be passed through the orientation or draw process a second time or repeated as necessary. Then, at 122, the stretched, and now oriented, drawn yarn is passed through an oven and heat treated to reduce shrinkage through heat and relaxation.

At 124, the drawn and heat treated yarns from 122 are beamed into a warp. The resulting warp will placed on a loom at 126 and becomes the machine direction yarns. In example embodiments, a projectile and a rapier loom are used; however, those skilled in the art will appreciate that other looms may also be used.

At 128, the polymer fabric according to an example embodiment of the present invention is woven by introducing a cross direction (fill) yarn to the machine direction (warp) yarns from the warp. The type or configuration of the weave used, such as for example a plain weave, twill weave, basket weave, satin weave, and the like, of the resulting woven polymer fabric can be varied depending on the motion of harnesses on the loom. Additionally, in example embodiments, the cross direction yarn is introduced to the machine direction yarns at a right angle. However, those skilled in the art will appreciate that the cross direction yarns may be introduced at other angles and such practice is within the scope of the present invention.

Lastly, at 130, the woven polymer fabric from 128 is processed though one or more finishing processes as required by its end use. Finishing processes include for example such heat setting, calendaring, slitting, and inspecting among other known finishing processes.

As detailed in the example applications described herein, particular materials are processed and extruded, which are further processed to form woven fabrics for various applications as detailed herein. According to example embodiments, specification sheets for each of the following applications and end-use fabrics are detailed in Appendix I.

In some example embodiments of the present invention, the woven polymer fabric is a diatomaceous earth (DE) pool filter or fabric for DE grid pool filters. The DE pool filter fabric comprises warp yarns and fill yarns wherein both the warp yarns and fill yarns are fibrillated tape yarns made from a virgin polypropylene resin and low density polyethylene (LDPE) or linear low-density polyethylene (LLDPE). The fibrillated tape yarns comprise between about 95% and about 98% virgin polypropylene resin by volume and between about 2.0% and about 5.0% LDPE or LLDPE by volume. The fibrillated tape yarn is formed using a coat hanger extrusion die. According to example embodiments, both the warp yarns and fill yarns further comprise an antimicrobial additive, for example, TOSAF B18726HP. Optionally, other desired antimicrobial additives can be chosen as desired.

In other example embodiments of the present invention, the woven polymer fabric is a monofilament pool cartridge filter or filter fabric for monofilament cartridge pool filters. The monofilament cartridge pool filter fabric comprises warp yarns and fill yarns wherein the warp yarns are monofilament yarns made from a virgin polypropylene resin and a carbon black additive. The monofilament yarns comprise between about 78% and about 98% virgin polypropylene by volume and between about 5.25% and about 6.0% carbon black additive by volume. According to example embodiments, the warp yarns further comprise an antimicrobial additive, for example, TOSAF B18726HP. Optionally, other desired antimicrobial additives can be chosen as desired. The fill yarns of the monofilament cartridge pool filter fabric do not comprise any antimicrobial additives.

In yet another example embodiment of the present invention, the woven polymer fabric is a mat for trampolines. The trampoline mat comprises a first set of warp yarns with antimicrobial additives, a second set of warp yarns without antimicrobial additives, and fill yarns without antimicrobial additives. The first set of warp yarns are fibrillated tape yarns made from a virgin polypropylene resin and low density polyethylene (LDPE) or linear low-density polyethylene (LLDPE). The fibrillated tape yarns comprise between about 95% and about 98% virgin polypropylene resin by volume and between about 2.0% and about 5.0% LDPE or LLDPE by volume. The fibrillated tape yarn is formed using a coat hanger extrusion die. According to example embodiments, the first set of warp yarns comprises an antimicrobial additive, for example, TOSAF B18726HP. Optionally, other desired antimicrobial additives can be chosen as desired.

According to another example embodiment of the present invention, the polymer woven fabric is a boundary/containment net and/or fencing barrier. For example, according to some example embodiments, one or more polymer yarns (at least one of which comprises antimicrobial additives), can be woven to form an antimicrobial polymer fabric for use as a boundary or net/fence for surrounding the perimeter of the trampoline, thereby acting as a boundary so that users or participants are prevented from falling off of the trampoline unintentionally. In example embodiments, the antimicrobial properties thereof preferably substantially minimize, if not entirely eliminate, the potential for any bacteria, virus, or fungi from collecting and/or growing thereon.

While the invention has been described with reference to example embodiments, it will be understood by those skilled in the art that a variety of modifications, additions and deletions are within the scope of the invention, as defined by the following claims.

What is claimed is:

1. A composition for a polymer yarn comprising at least one polymer and at least one antimicrobial additive.

2. The composition of claim 1, wherein the at least one antimicrobial additive is antiviral.

3. The composition of claim 1, wherein the at least one antimicrobial additive is antifungal.

4. The composition of claim 1, wherein the at least one antimicrobial additive is antibacterial.

5. A polymer yarn comprising the composition of claim 1.

6. The polymer yarn of claim 5, wherein the polymer yarn is a monofilament yarn comprising between 78% and 98% of virgin polypropylene and between 5.25% and 6% of carbon black additive.

7. The polymer yarn of claim 5, wherein the polymer yarn is a fibrillated tape yarn comprising between 95% and 98% of virgin polypropylene and between 2% and 5% of low density polyethylene or linear low-density polyethylene.

8. A woven polymeric fabric comprising a plurality of polymer yarns of claim 5.

9. The woven polymeric fabric of claim 8 configured for use with a diatomaceous earth pool filter.

10. The woven polymeric fabric of claim 8 configured for use with a monofilament pool cartridge filter.

11. The woven polymeric fabric of claim 6 configured for use as a trampoline mat.

12. The method of weaving an antimicrobial polymeric material, comprising:
introducing antimicrobial additives to a polymer resin;
loading the antimicrobial additives and the polymer resin into an extruder;
melting and blending together the polymer resin and antimicrobial additives into a resin mixture;
extruding the resin mixture through a die to form extruded yarns;
quenching the extruded yarns into solid, unoriented yarns;
passing the solid, unoriented yarns through a draw process to produce drawn yarns;
beaming the drawn yarns into a warp;
placing the warp on a loom; and
weaving the antimicrobial polymeric material by introducing cross direction yarns to the drawn yarns of the warp.

13. The method of claim 12, wherein the die is a monofilament die and the extruded yarns are monofilament yarns.

14. The method of claim 12, wherein the die is a coat hanger die and the extruded yarns are fibrillated tape yarns.

15. The method of claim 12, wherein the solid, unoriented yarns are passed through the draw process more than one time.

16. The method of claim 12, further comprising the step of passing the drawn yarns through an oven after the draw process.

17. The method of claim 12, wherein the drawn yarns beamed into the warp are machine direction yarns.

18. The method of claim 12, wherein the antimicrobial polymeric material is weaved on a projectile and a rapier.

19. The method of claim 12, wherein the cross machine direction yarn is introduced to the drawn yarns of the warp at a right angle.

20. The method of claim 12, further comprising a finishing process including heat setting, calendaring, and slitting.
